(19) United States
(12) Patent Application Publication
(10) Pub. No.: US 2010/0160053 A1
(43) Pub. Date: Jun. 24, 2010

(54) Boot for universal joint

(76) Inventor: Shigeru Okubo, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/308,382

(22) PCT Filed: Jun. 13, 2007
(86) PCT No.: PCT/JP2007/061856

§ 371 Date: Dec. 12, 2008

(51) Int. Cl. F16D 3/84

(52) U.S. Cl. 464/175

(57) ABSTRACT

A boot has a large diameter tube section, a small diameter tube section, and a bellows section for connecting the large diameter tube section and the small diameter tube section. The bellows section has, in a continuous manner, first to sixth crest sections and first to sixth root sections. The angles of opening of the inner peripheral surfaces of the crests of the first to third crest sections are set smaller than the angles of opening of the inner peripheral surfaces of the crests of the fourth to sixth crest sections. Further, the wall thicknesses of tilt sections are set smaller than the wall thickness of tilt sections.

### TECHNICAL FIELD

The present invention relates to a universal joint boot comprising a large-diameter member into which an outer member of a universal joint is inserted, a small-diameter member into which a shaft of the universal joint is inserted, and a bellows member interconnecting the large-diameter member and the small-diameter member, wherein the bellows member becomes progressively smaller in diameter from the large-diameter member toward the small-diameter member.

### BACKGROUND ART

Constant velocity universal joints for use on vehicles such as automobiles are known as universal joints. A typical universal joint includes a flexible boot made of rubber or synthetic resin. The boot comprises a large-diameter member into which an outer member (outer ring) of the universal joint is fixedly inserted, a small-diameter member into which a shaft of the universal joint is fixedly inserted, and a bellows member interconnecting the large-diameter member and the small-diameter member and having an alternate succession of peaks and valleys.

Recently, there has been a demand for constant velocity universal joints having smaller and lighter boots. However, smaller boots are disadvantageous in that the bellows member, when expanded, tends to be insufficient in length. Moreover, when a high operational angle is imparted to the boot, the smaller boot is expanded and contracted to a larger extent, reducing durability thereof. Furthermore, when the boot is axially contracted, the pitch between the peaks and valleys of the boot becomes smaller, causing frictional wear, which results in the boot becoming less durable when the boot is compressed.

Japanese Laid-Open Patent Publication No. 10-299789 discloses a flexible boot. As shown in FIG. 4 of the accompanying drawings, the disclosed flexible boot comprises an intermediate bellows member 1, together with a smaller-diameter mount member 2 and a larger-diameter mount member 3, which are disposed at respective opposite ends of the bellows member 1. The bellows member 1 includes an alternate succession of peaks and valleys, i.e., a first peak 1a, a first valley 1b, a second peak 1c, a second valley 1d, a third peak 1e, and a third valley 1f, which are arranged in order from the smaller-diameter mount member 2. The larger-diameter mount member 3 is fixed to an outer tubular member of a joint (not shown), whereas the smaller-diameter mount member 2 is fixed to the joint shaft.

The flexible boot has a reference position O, where it is held against the end face of the outer tubular member of the joint. A distance b from the reference position O to the center of the third valley if of the bellows member 1 is within a range of from 30% to 40% the distance a from the reference position O to the center of the third peak 1e. Even if the length of the bellows member 1 is small, the bellows member has dimensions that are large enough to reduce deforming stresses of the third valley 1f, which undergoes the greatest deformation when the flexible boot is in operation, so that contact between the valleys can be reduced when the flexible boot is compressed.

As shown in FIG. 4, in the flexible boot disclosed in Japanese Laid-Open Patent Publication No. 10-299788, the diameter D2 of the inner circumferential surface of the third peak 1e of the flexible boot is greater than the diameter D1 of the outer circumferential surface of the larger-diameter mount member 3. Therefore, when the flexible boot is compressed, a crest of the third peak 1e does not become pinched between the larger-diameter mount member 3 and the second peak 1c. Accordingly, concentration of stress on the third peak 1e can be reduced.

However, the flexible boots referred to above cannot easily be reduced in weight, since the bellows member 1 has a relatively large wall thickness.

The inner circumferential surface of the third peak 1e, positioned nearer to the larger-diameter mount member 3, has wall surfaces that are angularly spaced from each other by a much larger open angle than the inner circumferential surface of the first peak 1a, which is positioned nearer to the smaller-diameter mount member 2. Such an angular setting makes it difficult to reduce the amount of grease required to fill the flexible boot. When the flexible boot is axially pressed, the distance by which the third peak 1e nearer to the larger-diameter mount member 3 is axially compressed is too small to reduce the amount of grease required to fill the flexible boot.

### DISCLOSURE OF THE INVENTION

It is an object of the present invention to provide a universal joint boot having a desired level of durability, which can easily be reduced in size and weight, and can be constructed economically.

According to the present invention, there is provided a universal joint boot comprising a large-diameter tubular member into which an outer member of a universal joint is inserted, a small-diameter tubular member into which a shaft of the universal joint is inserted, and a bellows member interconnecting the large-diameter tubular member and the small-diameter tubular member, the bellows member becoming progressively smaller in diameter from the large-diameter tubular member toward the small-diameter tubular member.

According to an aspect of the present invention, the bellows member includes an alternate succession of peaks and valleys. Each of the peaks includes an inner circumferential surface having wall surfaces angularly spaced from each other by an open angle, wherein the open angles of peaks that are closer to the larger-diameter tubular member are smaller than the open angles of peaks that are closer to the smaller-diameter tubular member. The peaks and valleys are coupled to each other by slanted walls, wherein the slanted wall that interconnects the peak and valley closest to the smaller-diameter tubular member is smaller in wall thickness than the slanted wall that interconnects the peak and valley closest to the larger-diameter tubular member.

According to another aspect of the present invention, the bellows member includes an alternate succession of peaks and valleys. Each of the peaks includes an inner circumferential surface having wall surfaces angularly spaced from each other by an open angle, wherein the open angles of peaks that are closer to the larger-diameter tubular member are smaller than the open angles of peaks that are closer to the smaller-diameter tubular member. The peaks and valleys are spaced from each other by peak-to-valley distances, wherein the peak-to-valley distance between the peak and valley closest to the smaller-diameter tubular member is smaller than the peak-to-valley distance between the peak and valley closest to the larger-diameter tubular member.

According to still another aspect of the present invention, the bellows member includes an alternate succession of peaks and valleys. The peaks and valleys are coupled to each other by slanted walls, wherein the slanted wall that interconnects the peak and valley closest to the smaller-diameter tubular member is smaller in wall thickness than the slanted wall that interconnects the peak and valley closest to the larger-diameter tubular member. The peaks and valleys are spaced from each other by peak-to-valley distances, wherein the peak-to-valley distance between the peak and valley closest to the smaller-diameter tubular member is smaller than the peak-to-valley distance between the peak and valley closest to the larger-diameter tubular member.

According to yet another aspect of the present invention, the bellows member includes an alternate succession of peaks and valleys. Each of the peaks includes an inner circumferential surface having wall surfaces angularly spaced from each other by an open angle, wherein the open angles of peaks that are closer to the larger-diameter tubular member are smaller than the open angles of peaks that are closer to the smaller-diameter tubular member. The peaks and valleys are coupled to each other by slanted walls, wherein the slanted wall that interconnects the peak and valley closest to the smaller-diameter tubular member is smaller in wall thickness than the slanted wall that interconnects the peak and valley closest to the larger-diameter tubular member. The peaks and valleys are spaced from each other by peak-to-valley distances, wherein the peak-to-valley distance between the peak and valley closest to the smaller-diameter tubular member is smaller than the peak-to-valley distance between the peak and valley closest to the larger-diameter tubular member.

As described above, the open angles of peaks that are closer to the larger-diameter tubular member are smaller than the open angles of peaks that are closer to the smaller-diameter tubular member. Consequently, when pressing forces are applied axially to the universal joint boot, the peaks closer to the larger-diameter tubular member are collapsed and axially compressed. The volume of space inside the universal joint boot is reduced, thereby reducing the amount of grease required to fill the universal joint boot, and thus making the universal joint boot more economical.

As described above, the slanted wall that interconnects the peak and valley closest to the smaller-diameter tubular member is smaller in wall thickness than the slanted wall that interconnects the peak and valley closest to the larger-diameter tubular member. Therefore, when the universal joint boot is compressed, the bellows member is prevented from frictional sliding, and wearing of the joint boot is prevented as a whole. Further, the overall weight of the universal joint boot can be reduced.

As described above, the peak-to-valley distance between the peak and valley closest to the smaller-diameter tubular member is smaller than the peak-to-valley distance between the peak and valley closest to the larger-diameter tubular member. Consequently, the universal joint boot can be reduced in size, and the amount of grease required to fill the universal joint boot can easily be reduced.

### BRIEF DESCRIPTION OF THE DRAWINGS

FIG. 1 is a longitudinal cross-sectional view, taken in an axial direction, of a universal joint boot according to the present invention, which is mounted on a constant velocity universal joint;

FIG. 2 is an enlarged longitudinal cross-sectional view of the universal joint boot before it is mounted on the constant velocity universal joint;

FIG. 3 is a longitudinal cross-sectional view showing the universal joint boot according to the present invention together with a conventional boot for comparison; and

FIG. 4 is a longitudinal cross-sectional view of flexible boots, as disclosed in Japanese Laid-Open Patent Publication No. 10-299789 and Japanese Laid-Open Patent Publication No. 10-299788.

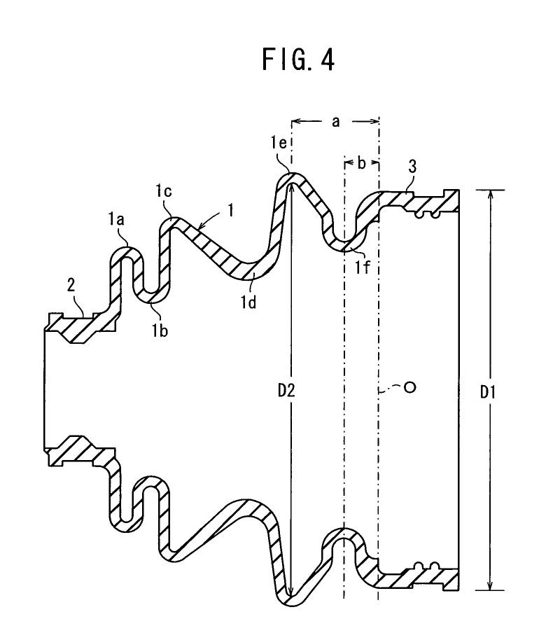

### BEST MODE FOR CARRYING OUT THE INVENTION

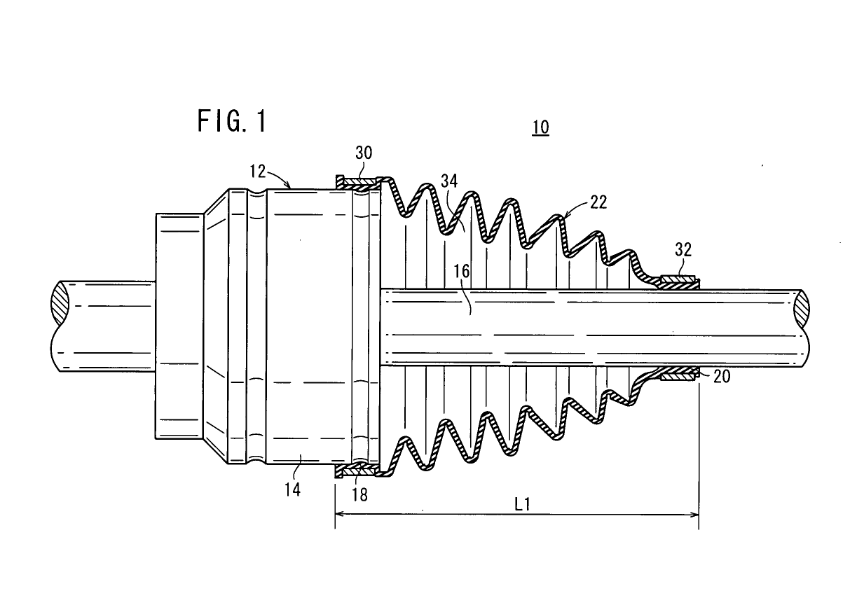

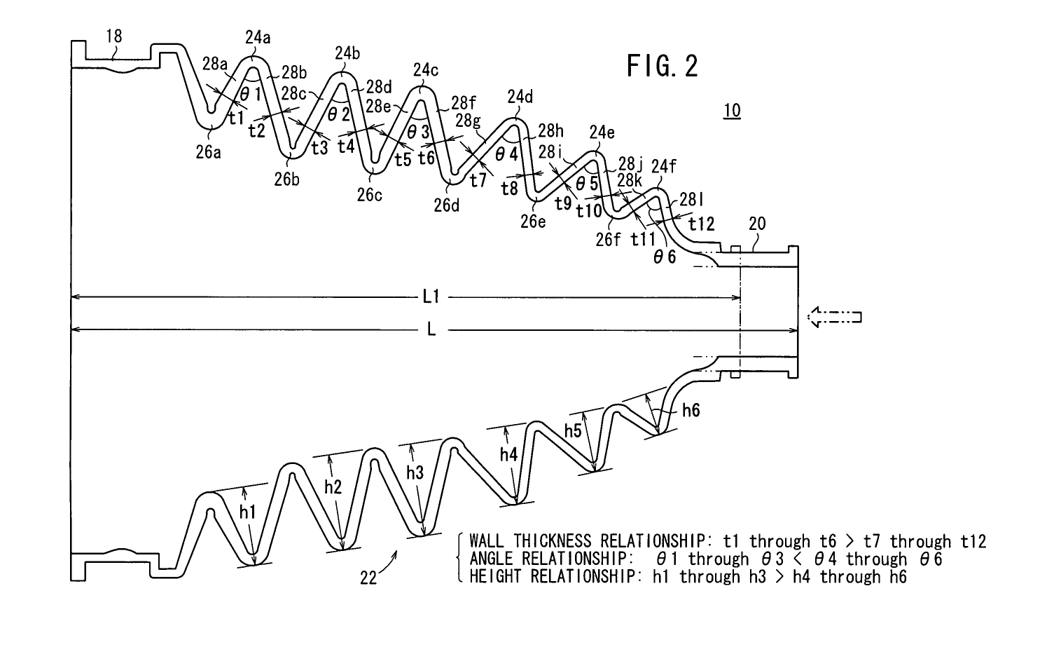

FIG. 1 shows in longitudinal cross section a universal joint boot 10 according to an embodiment of the present invention. The universal joint boot 10 is mounted on a universal joint, e.g., a constant velocity universal joint 12. FIG. 2 shows in enlarged longitudinal cross section the universal joint boot 10 before it is mounted on the constant velocity universal joint 12, i.e., when no external forces are applied to the universal joint boot 10.

As shown in FIG. 1, the constant velocity universal joint 12 comprises an outer member 14, which serves as an outer ring, and a shaft 16 tiltably coupled to the outer member 14. The universal joint boot 10 is made of rubber or synthetic resin, and comprises a large-diameter tubular member 18 into which the outer member 14 is inserted, a small-diameter tubular member 20 into which the shaft 16 is inserted, and a bellows member 22 interconnecting the large-diameter tubular member 18 and the small-diameter tubular member 20. The bellows member 22 becomes progressively smaller in diameter from the large-diameter tubular member 18 toward the small-diameter tubular member 20.

As shown in FIG. 2, the bellows member 22 includes a succession of peaks, i.e., a first peak 24a, a second peak 24b, a third peak 24c, a fourth peak 24d, a fifth peak 24e, and a sixth peak 24f, and a succession of valleys, i.e., a first valley 26a, a second valley 26b, a third valley 26c, a fourth valley 26d, a fifth valley 26e, and a sixth valley 26f, arranged in order from the smaller-diameter tubular member 18. The first through sixth peaks 24a through 24f and the first through sixth valleys 26a through 26f are integrally coupled to each other by slanted walls 28a through 28l.

The inner circumferential surface of the first peak 24a has wall surfaces angularly spaced from each other by an open angle θ1. In other words, the slanted walls 28a, 28b are angularly spaced from each other by the open angle θ1. Similarly, the inner circumferential surface of the second peak 24b has wall surfaces angularly spaced from each other by an open angle θ2, i.e., the slanted walls 28c, 28d are angularly spaced from each other by the open angle θ2. The inner circumferential surface of the third peak 24c has wall surfaces angularly spaced from each other by an open angle θ3, i.e., the slanted walls 28e, 28f are angularly spaced from each other by the open angle θ3. The inner circumferential surface of the fourth peak 24d has wall surfaces angularly spaced from each other by an open angle θ4, i.e., the slanted walls 28g, 28h are angularly spaced from each other by the open angle θ4. The inner circumferential surface of the fifth peak 24e has wall surfaces angularly spaced from each other by an open angle θ5, i.e., the slanted walls 28i, 28j are angularly spaced from each other by the open angle θ5. The inner circumferential surface of the sixth peak 24f has wall surfaces angularly spaced from each other by an open angle θ6, i.e., the slanted walls 28k, 28l are angularly spaced from each other by the open angle θ6. The open angles θ1 through θ3 are smaller than the open angles θ4 through θ6 (θ1 through θ3<θ4 through θ6).

The slanted walls 28a through 28l have respective wall thicknesses t1 through t12. The wall thicknesses t7 through t12 of the slanted walls 28g through 28l that are closer to the smaller-diameter tubular member 20 are smaller than the wall thicknesses t1 through t6 of the slanted walls 28a through 28f that are closer to the larger-diameter tubular member 18 (t1 through t6>t7 through t12).

The first peak 24a and the first valley 26a are spaced from each other by a peak-to-valley distance h1. The second peak 24b and the second valley 26b are spaced from each other by a peak-to-valley distance h2. The third peak 24c and the third valley 26c are spaced from each other by a peak-to-valley distance h3. The fourth peak 24d and the fourth valley 26d are spaced from each other by a peak-to-valley distance h4. The fifth peak 24e and the fifth valley 26e are spaced from each other by a peak-to-valley distance h5. The sixth peak 24f and the sixth valley 26f are spaced from each other by a peak-to-valley distance h6. The peak-to-valley distances h4 through h6 that are closer to the smaller-diameter tubular member 20 are smaller than the peak-to-valley distances h1 through h3 that are closer to the larger-diameter tubular member 18 (h1 through h3>h4 through h6).

As shown in FIG. 2, the universal joint boot 10 has a total length L when no external forces are applied thereto and before the universal joint boot 10 is mounted on the constant velocity universal joint 12. As shown in FIGS. 1 and 2, when the universal joint boot 10 is mounted on the constant velocity universal joint 12, the universal joint boot 10 has a total length L1. The total length L1 is within a range of from 83% to 90% the total length L.

As shown in FIG. 1, the outer member 14 is inserted into the larger-diameter tubular member 18, and the larger-diameter tubular member 18 is fixed to the outer circumferential surface of the outer member 14 by an annular band 30. The shaft 16 is inserted into the smaller-diameter tubular member 20, and the smaller-diameter tubular member 20 is fixed to the outer circumferential surface of the shaft 16 by another annular band 32. The bellows member 22 defines a hermetically sealed space 34 therein, which is filled with grease (not shown).

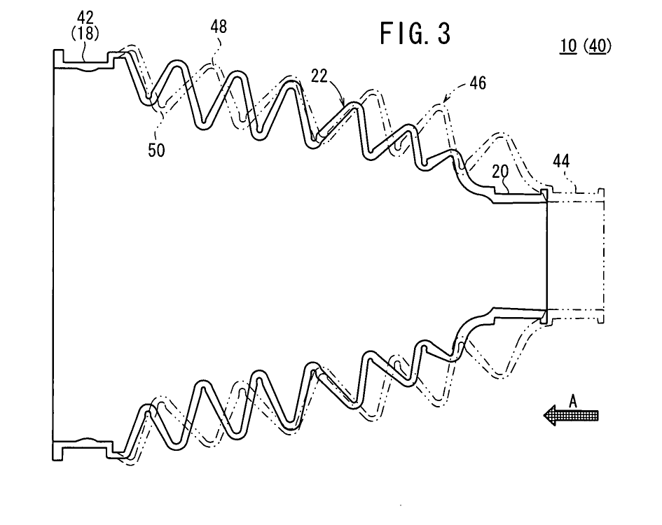

Operations and advantages of the universal joint boot 10 shall be described below with reference to FIG. 3, in comparison with a conventional boot 40.

The conventional boot 40 comprises a larger-diameter tubular member 42 and a smaller-diameter tubular member 44, which are integrally joined to each other by a bellows member 46. The bellows member 46 includes an alternate succession of five peaks 48 and five valleys 50 having a general configuration. The inner circumferential surface of each of the peaks 48 has wall surfaces angularly spaced from each other by a constant angle. Slanted walls, by which the peaks 48 and valleys 50 are joined to each other, also have a constant wall thickness. Further, the peaks 48 and valleys 50 are spaced from each other by a constant peak-to-valley distance.

As shown in FIG. 2, the universal joint boot 10 according to the present embodiment includes six peaks, including the first through sixth peaks 24a through 24f, and six valleys, including the first through sixth valleys 26a through 26f. Therefore, the universal joint boot 10 can axially be compressed to a greater extent in the axial direction than the conventional boot 40, as indicated by the arrow A (see FIG. 3).

Actually, the total length L1 of the universal joint boot 10, when mounted on the constant velocity universal joint 12, can be set to a compressed value within a range of from 83% to 90% the total length L of the universal joint boot 10 when no external forces are applied thereto (L1=L×0.83 through 0.9). Since the universal joint boot 10 has a greater number of peaks and valleys, stresses developed in the first through sixth valleys 26a through 26f are distributed, allowing higher compressive forces to be applied to the universal joint boot 10 than are possible using the conventional boot 40.

When the universal joint boot 10 is mounted on the constant velocity universal joint 12, therefore, the volume of space 34 defined inside the bellows member 22 is greatly reduced, so that the amount of grease required to fill the space 34 is reduced. The universal joint boot 10 is thus made more economical.

Further, according to the present embodiment, the open angles θ1 through θ3 of the inner circumferential surfaces of the first through third peaks 24a through 24c, which are closer to the larger-diameter tubular member 18, are smaller than the open angles θ4 through θ6 of the inner circumferential surfaces of the fourth through sixth peaks 24d through 24f, which are closer to the smaller-diameter tubular member 20. Consequently, when pressing forces are applied axially to the universal joint boot 10, the first through third peaks 24a through 24c having the smaller open angles θ1 through θ3 are collapsed and axially compressed.

With the above angular setting, the volume of space 34 defined inside the bellows member 22 is greatly reduced even further, and the amount of grease required to fill the space 34 is further reduced, thereby making the universal joint boot 10 more economical. Specifically, the amount of grease required to fill the space 34 is reduced by about 25%.

According to the present embodiment, moreover, the wall thicknesses t7 through t12 of the slanted walls 28g through 28l, which are closer to the smaller-diameter tubular member 20, are smaller than the wall thicknesses t1 through t6 of the slanted walls 28a through 28f, which are closer to the larger-diameter tubular member 18. Therefore, when the universal joint boot 10 is compressed, the bellows member 22 is prevented from frictional sliding, the bellows member 22 experiences less wearing as a whole, and the overall weight of the universal joint boot 10 is reduced. Specifically, the total weight of the universal joint boot 10 is about 15% smaller than that of the conventional boot 40, thus making the universal joint boot 10 more economical.

According to the present embodiment, the peak-to-valley distances h4 through h6, which are positioned closer to the smaller-diameter tubular member 20, are smaller than the peak-to-valley distances h1 through h3, which are positioned closer to the larger-diameter tubular member 18. Consequently, the universal joint boot 10 is reduced in overall size, and the volume of the space 34 is reduced. Therefore, the amount of grease required to fill the space 34 also is reduced.

In the present embodiment, the bellows member 22 includes six peaks, including the first through sixth peaks 24a through 24f. However, the bellows member 22 may also include five peaks, or alternatively, the bellows member 22 may be formed with seven or more peaks.

Among the open angles θ1 through θ3 of the inner circumferential surfaces of the first through third peaks 24a through 24c, only the open angle θ1 of the inner circumferential surface of the first peak 24a may be formed to be smaller than the open angles θ4 through θ6 of the inner circumferential surfaces of the fourth through sixth peaks 24d through 24f.

Among the wall thicknesses t7 through t12 of the slanted walls 28g through 28l, the wall thickness of at least one slanted wall, which tends to slide frictionally, is smaller than the wall thicknesses t1 through t6 of the slanted walls 28a through 28f. At least one of the peak-to-valley distances h4 through h6 is smaller than the peak-to-valley distances h1 through h3.

Furthermore, the total length L1 of the universal joint boot 10 when the universal joint boot 10 is mounted on the constant velocity universal joint 12 is set to have a compressed value within a range of from 83% to 90% the total length L of the universal joint boot 10 when external forces are not applied thereto. If the compressed value is in excess of 91%, then the open angles of the inner circumferential surfaces become too large to permit sufficient axial expansion of the bellows member 22, which tends to undergo low-temperature buckling and flexural fatigue. If the compressed value is smaller than 83%, then the universal joint boot 10 is liable to contact the shaft 16 under a large pressure, and the universal joint boot 10 is likely to wear intensively due to frictional contact with the shaft 16, wherein the bellows member 22 suffers from increased contact pressure, developing wear and causing an increase in noise.

1. A universal joint boot comprising:
a large-diameter tubular member into which an outer member of a universal joint is inserted;
a small-diameter tubular member into which a shaft of the universal joint is inserted; and
a bellows member interconnecting said large-diameter tubular member and said small-diameter tubular member, said bellows member becoming progressively smaller in diameter from said large-diameter tubular member toward said small-diameter tubular member.
wherein said bellows member includes an alternate succession of peaks and valleys;
each of said peaks includes an inner circumferential surface having wall surfaces angularly spaced from each other by an open angle, wherein the open angles of peaks that are closer to said larger-diameter tubular member are smaller than the open angles of peaks that are closer to said smaller-diameter tubular member; and
said peaks and valleys are coupled to each other by slanted walls, wherein the slanted wall that interconnects the peak and valley closest to said smaller-diameter tubular member is smaller in wall thickness than the slanted wall that interconnects the peak and valley closest to said larger-diameter tubular member.

2. A universal joint boot comprising:
a large-diameter tubular member into which an outer member of a universal joint is inserted;
a small-diameter tubular member into which a shaft of the universal joint is inserted; and
a bellows member interconnecting said large-diameter tubular member and said small-diameter tubular member, said bellows member becoming progressively smaller in diameter from said large-diameter tubular member toward said small-diameter tubular member;
wherein said bellows member includes an alternate succession of peaks and valleys;
each of said peaks includes an inner circumferential surface having wall surfaces angularly spaced from each other by an open angle, wherein the open angles of peaks that are closer to said larger-diameter tubular member are smaller than the open angles of peaks that are closer to said smaller-diameter tubular member; and
said peaks and valleys are spaced from each other by peak-to-valley distances, wherein the peak-to-valley distance between the peak and valley closest to said smaller-diameter tubular member is smaller than the peak-to-valley distance between the peak and valley closest to said larger-diameter tubular member.

3. A universal joint boot comprising:
a large-diameter tubular member into which an outer member of a universal joint is inserted;
a small-diameter tubular member into which a shaft of the universal joint is inserted; and
a bellows member interconnecting said large-diameter tubular member and said small-diameter tubular member, said bellows member becoming progressively smaller in diameter from said large-diameter tubular member toward said small-diameter tubular member;
wherein said bellows member includes an alternate succession of peaks and valleys;
said peaks and valleys are coupled to each other by slanted walls, wherein the slanted wall that interconnects the peak and valley closest to said smaller-diameter tubular member is smaller in wall thickness than the slanted wall that interconnects the peak and valley closest to said larger-diameter tubular member; and
said peaks and valleys are spaced from each other by peak-to-valley distances, the peak-to-valley distance between the peak and valley closest to said smaller-diameter tubular member is smaller than the peak-to-valley distance between the peak and the valley closest to said larger-diameter tubular member.

4. A universal joint boot comprising:
a large-diameter tubular member into which an outer member of a universal joint is inserted;
a small-diameter tubular member into which a shaft of the universal joint is inserted; and
a bellows member interconnecting said large-diameter tubular member and said small-diameter tubular member, said bellows member becoming progressively smaller in diameter from said large-diameter tubular member toward said small-diameter tubular member;
wherein said bellows member includes an alternate succession of peaks and valleys;
each of said peaks includes an inner circumferential surface having wall surfaces angularly spaced from each other by an open angle, wherein the open angles of peaks that are closer to said larger-diameter tubular member are smaller than the open angles of peaks that are closer to said smaller-diameter tubular member;
said peaks and valleys are coupled to each other by slanted walls, wherein the slanted wall that interconnects the peak and valley closest to said smaller-diameter tubular member is smaller in wall thickness than the slanted wall that interconnects the peak and valley closest to said larger-diameter tubular member; and
said peaks and said valleys are spaced from each other by peak-to-valley distances, wherein the peak-to-valley distance between the peak and valley closest to said smaller-diameter tubular member is smaller than the peak-to-valley distance between the peak and valley closest to said larger-diameter tubular member.

5. A universal joint boot according to claim 1, wherein when said universal joint boot is mounted on said universal joint, the mounted universal joint boot has a total length set to a compressed value in a range of from 83% to 90% the total length of the universal joint boot in an unmounted state when no external forces are applied thereto, before said universal joint boot is mounted on said universal joint.

6. A universal joint boot according to claim 1, wherein said universal joint comprises a constant velocity universal joint for use on a vehicle.
